(19) United States
(12) Patent Application Publication
(10) Pub. No.: US 2009/0282757 A1
(43) Pub. Date: Nov. 19, 2009

(54) Horse Protectors

(75) Inventor: Eric Douglas Ferguson, Newark, DE (US)

Correspondence Address: Eric Douglas Ferguson, 934 Old Baltimore Pike, Newark, DE, 19702, US

(73) Assignee: Eric Douglas Ferguson, Newark, DE (US)

(21) Appl. No.: 12/387,683

(22) Filed: May 5, 2009

Related U.S. Application Data
(60) Provisional application No. 61/126,406, filed on May 5, 2008.

(51) Int. Cl. E06B 3/26

(52) U.S. Cl. 52/202

(57) ABSTRACT

A horse protector is used to provide protection to an equine while transitioning from one area to another through a doorway, walkway, gate, breezeway, isle way, or any other type of framed transitional area and can also be installed on horse trailers. A horse protector is molded out of a durable, cushioned, poly material. It is installed using screws, nails, staples, glue, Velcro, or any other type of fastener.

### CROSS REFERENCE TO RELATED APPLICATIONS

This application claims the benefit of U.S. Provisional Patent Application No. 61/126,406, which is incorporated by reference herein.

### FIELD OF THE INVENTION

The present invention relates to the protection of any type of animal. More particularly, it provides protection when transitioning from the interior of any enclosed area to the exterior of an enclosed area or vice versa or any other area which has framework comprised of a rigid material lacking any give including but not limited to fencing, gates, horsetrailers, stall doorways, run-in sheds, round pens, portable stalls, and barn entryways and exits.

### BACKGROUND OF THE INVENTION

The invention will be described as a protective device most commonly installed on stall doorway framework to protect an equine's hip area, but persons skilled in caring for all types of animals will recognize that the present invention is applicable to other types of transitional areas and can be used by a wide variety of animal owners.

It is common for a horse to brush, bump or scrape it's body on the framework of the doorway of a stall resulting in injury. What is needed is a flexible, forgiving, cushioned barrier to protect the animal while transitioning into and out of a stall.

Although there are known products which restrict a horse to it's stall and protect only their legs while in the stall there are no known products offering this type of protection.

### SUMMARY OF THE INVENTION

The present invention provides a device which installs to the framework of any doorway or rigid surface that would potentially cause injury to any type of animal while transitioning from one area to another. The invention may be made of a non-toxic material which may or may not be porous, can be of any color, may be pliable, may be durable, and may be attached to the rigid installation surface using any method desired including but not limited to screws, staples, Velcro, glue and nails. The invention may be portable so that it is able to be removed and reinstalled elsewhere.

The invention then cushions the area it is installed against whereby reducing the risk of the animal obtaining an injury while passing by the area.

### BRIEF DESCRIPTION OF THE FIGURES

FIG. 1 is a frontal view of the invention as described above.

FIG. 2 is a frontal view of the invention installed on both sides of a doorway frame.

FIG. 3 is an additional frontal view of the invention installed on both sides of a doorway frame. It also shows the invention installed on the top of the doorway frame.

FIG. 4 is a close up color view of the invention illustrating the width and depth of the invention when installed properly on a doorway frame.

### DETAILED DESCRIPTION

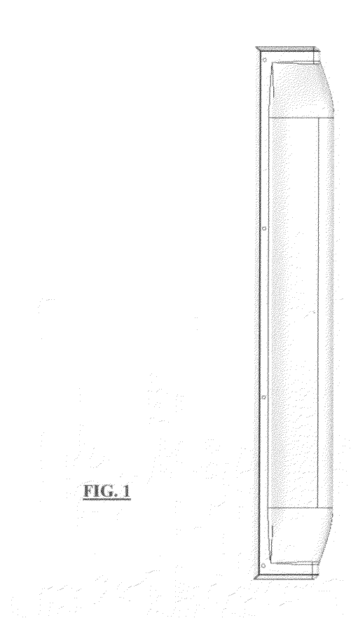

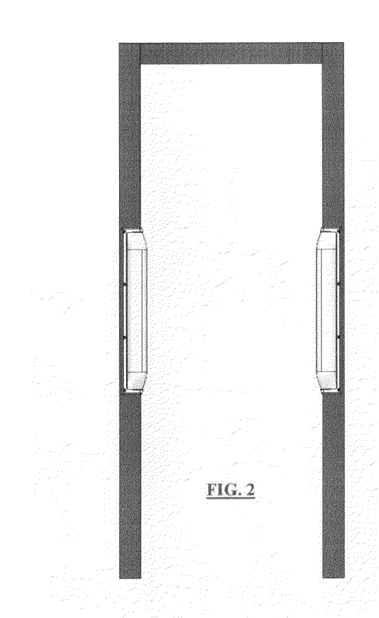

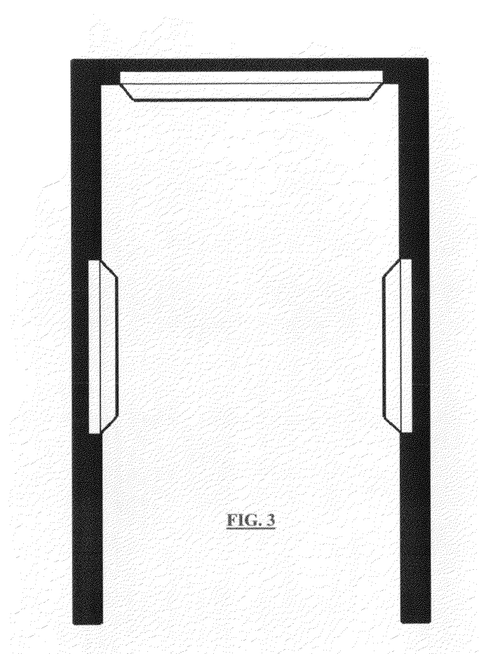

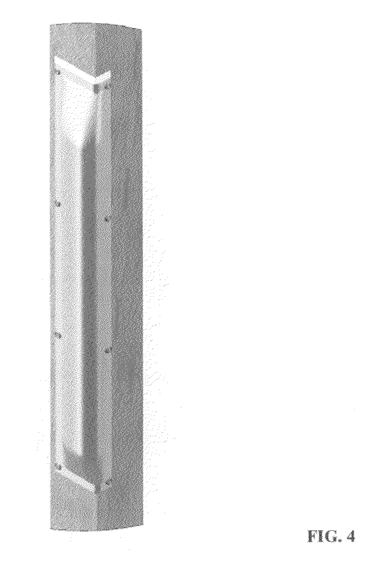

Referring to the drawing in FIG. 1 the finished piece is made by molding any type of poly compound or rubber based material such as poly vinyl chloride. The invention in FIG. 1 is illustrated with holes which allow screws to pass through so that the invention may be fastened to any rigid material via these holes as shown in FIG. 4. The invention as shown in FIG. 2 is able to be installed on opposite sides of a doorway. In FIG. 3 the invention is also installed on the top of the doorway.

The invention in FIG. 1 is able to be molded to any desired length with the standard length being thirty inches. The width of the invention is typically 4.375 inches but can be adjusted to order. The depth of the invention should not be less than 2.938 inches but can be more. The majority of the cushioned area measures approximately twenty two inches in length and narrows at both the top and bottom of the invention as shown in FIGS. 1, 2 and 4.

The invention the may be installed on either side of a doorway as depicted in FIG. 3 and is not molded in pairs. Likewise, there is no top or bottom of the invention nor are they right or left sided.

What is claimed is:

1. A horse protector which comprises:
a molded material taken from a group consisting essentially of poly, poly vinyl chloride, or rubber, which is any color and may be pliable, which may be durable but should be non-toxic.

2. The structure of claim 1, wherein said invention is installed to a rigid surface.

3. The structure of claim 2, wherein a group consisting essentially of screws, staples, Velcro, glue and nails are securing the invention.
